(19) United States
(12) Patent Application Publication
(10) Pub. No.: US 2014/0116966 A1
(43) Pub. Date: May 1, 2014

(54) HIGH PRESSURE FLUID FILTER SYSTEM

(71) Applicant: Robert Dennis Podsadowski, Manchester, NH (US)

(72) Inventor: Robert Dennis Podsadowski, Manchester, NH (US)

(21) Appl. No.: 14/065,140

(22) Filed: Oct. 28, 2013

Related U.S. Application Data
(60) Provisional application No. 61/795,947, filed on Oct. 31, 2012.

(51) Int. Cl. B01D 35/30

(52) U.S. Cl. CPC B01D 35/30
USPC 210/791; 210/435; 210/767

(57) ABSTRACT

A fluid filter system to be used in pressure washers, high power cleaning devices, heating systems or other hydraulic equipment systems that deliver high pressure fluid through pressure lines. More particularly the present invention is related to a resilient, reusable, pre-tool filter system that is installed within the high pressure fluid flow path between the output of the high pressure pumping system and the high pressure fluid tool attachment, fluid power equipment or other high pressure device

### RELATED APPLICATION

This application claims the benefit of U.S. Provisional Application No. 61/795,947 filed Oct. 31, 2012 entitled Clear jet which is incorporated herein by reference in its entirety.

### FIELD OF THE INVENTION

This invention relates to a fluid filter system to be used in pressure washers, high power cleaning devices, fuel oil heating systems or other hydraulic equipment and systems that deliver high pressure fluid through pressure lines. More particularly the present invention is related to a reusable, pre-tool filter system that is installed within the fluid flow path between the output of the high pressure pumping, heating or power system and the high pressure tool attachment fluid power equipment.

### BACKGROUND OF THE INVENTION

Pressure washers are well known using various pump arrangements to pump liquid supplied from an external source such as a water supply hose through a spray nozzle, brush, wand or other cleaning device at high pressures. The pumping system controls the flow through the hose by turning an electric motor or internal combustion motor driving the pump on or off. If the outlet flow path becomes clogged the flow of liquid through the hose is controlled by a bypass valve that re-directs liquid from the fluid flow path of the cleaning device to recirculate through the pressure washer system to cool the motor and pump. While all pressure washer systems have filtering systems at the inlet of the pump to remove particulates from the incoming liquid supply, a clog may occur in the outlet lines to the cleaning device due to for example using pressure lines that have not been used very frequently. Particulates from a dirty pressure line are forced under pressure to the tool attachment, clogging a spray head nozzle or brush jets. The user must then shut down the system, disconnect the tool attachment, and spend significant amounts of time cleaning and removing these particulates from the nozzle or brush components. The present invention provides an effective in line liquid filter system to remove particulates prior to the cleaning device tool that improves efficiency by preventing and/or reducing the time needed for cleaning and removing clogs.

Hydraulic power systems used in construction equipment, hydraulic motors and cylinders similarly use high pressure lines to deliver fluid to move earth moving machinery, power tools or operate other mechanical devices. The high pressure fluid filter system of the present invention may be installed to assist in preventing particulates from entering an engine or piston cylinder improving the overall performance of the machinery.

### OBJECTS AND SUMMARY OF THE INVENTION

The present invention relates to a reusable, pre-tool high pressure fluid filter system that is installed in the pressure lines of high pressure cleaning appliances, pressure washers, fuel oil heating systems or other hydraulic fluid systems and equipment. The pre-tool filter system is uniquely designed with an exterior threaded filter that provides for use in a variety of high pressure systems and an interior threaded casing that easily attaches and detaches from the outlet pressure lines of the high pressure system to provide for a user to clean the pre-tool filter system as necessary and reattach with minimal down time.

An object of the invention is to provide a pre-tool filter system that is easily attachable and detachable from the outlet pressure lines of high pressure cleaning appliances, pressure washers or other high pressure hydraulic fluid systems. The ease of attachment and detachment helps the user save time allowing a quick detachment of the filter system for cleaning rather than the user having to remove and clean numerous pieces of complex high pressure tools and equipment. The debris is captured along the flow path at the pre-tool filter system reducing or removing the necessity of having to locate a potential blockage within lengthy pressure lines or within the equipment and machinery of the high pressure system.

Another object of the invention is to maintain high pressure fluid flow through the system. The pre-tool filter system provides for fluid flow to remain at high pressures while collecting particulates and preventing clogging of tools or equipment.

Another object of the invention is the reduction in pulsation of high pressure fluid lines when the pre-tool filter system is installed.

Another object of the invention is to filter liquid flowing through the high pressure system post-outlet and pre-tool where one or more pre-tool filter systems may be placed along the flow path, especially in equipment using lengthy hydraulic lines of for example lines of several hundred feet.

Another object of the pre-tool filter system is to provide a removable filter system that may be cleaned and rapidly reattached and be reused.

Another object of the pre-tool filter system is to provide a mesh filter of a rigid, layered material formed from a perforated cylindrical pipe and an accordion shaped outer filter that surrounds the pipe creating a resilient filter that cannot be easily degraded, deformed or compressed and therefore can be reused through numerous high pressure power, wash and cleaning cycles.

The present invention is related to an apparatus for removing particulates from a high pressure fluid line. The apparatus comprises a dual threaded connector; a filter having outer threading; a casing having inner threading; and wherein the outer threading of the filter is attached to inner threading on the dual threaded connector, the inner threading on the casing is connected to outer threading on the dual threaded connector, the dual threaded connector and casing are connected in line with a high pressure fluid line and the filter removes particulates from fluid within the fluid line. The filter of the apparatus for removing particulates from a high pressure fluid line further comprises a rigid, cylindrical mesh filter layered within an accordion shaped filter that is resiliently formed to be reused through numerous high pressure fluid power, wash and cleaning cycles. The filter further comprises a material having perforations in a range of 50 microns to 250 microns. The dual threaded connector of further comprises a recess for an O-ring within the connector's outer threading, and a radius for an O-ring at the base of the connector's inner threading. The filter comprises a recess for an O-ring within the filter's outer threading, and the casing comprises a radius for an O-ring at the base of the casing's inner threading. The dual threaded connector, filter and casing further comprise parallel, fastening threads and at least one O-ring is used at each connection to form a seal. In an embodiment, an O-ring is used to seal the filter to the dual threaded connector. The O-ring is positioned at the recess of the filter to seal at the radius of the dual threaded connector. An O-ring is used to seal the casing to the dual threaded connector and the O-ring is positioned at the recess of the dual threaded connector to seal at the radius of the casing.

The present invention is further related to a pre-tool high pressure filter that comprises a dual threaded connector; a mesh filter having outer threading; a casing having inner threading; and wherein the outer threading of the mesh filter is attached to inner threading on the dual threaded connector, the inner threading on the casing is connected to outer threading on the dual threaded connector, the dual threaded connector and casing are removably attached prior to a tool attachment of high pressure fluid system and the pre-tool high pressure filter removes particulates from the fluid of the high pressure fluid system. The pre-tool high pressure filter may be removed, cleaned and re-attached prior to the tool attachment of the high pressure fluid system without disassembly of the tool attachment. The pre-tool high pressure filter may also be of a smaller micron rating than an internal filter of the tool attachment. The pre-tool high pressure filter may be used in the high pressure fluid systems used in construction equipment, in carpet cleaning equipment, fuel oil heating systems or in other high pressure fluid system devices.

The present invention is further related to a method of installing a reusable pre-tool high pressure filter, comprising the steps of inserting the outer threads of a mesh filter into inner threading of a dual threaded connector; twisting the mesh filter to form a seal; inserting the outer threads of the dual threaded connector into the inner threads of a high pressure casing; twisting the casing to form a seal; attaching the inlet port of the high pressure casing to a high pressure fluid line; attaching an outlet port of the dual threaded connector to a high pressure fluid tool attachment; and filtering particulates from the fluid within the high pressure fluid line. The method may further comprise the steps of detaching the inlet port of the high pressure casing from the high pressure fluid line; twisting the casing to remove the casing from the dual threaded connector; twisting the mesh filter to remove the filter from the dual threaded connector; cleaning the mesh filter; twisting the mesh filter within the inner threads of the dual threaded connector to form a seal; inserting the outer threads of the dual threaded connector into the inner threads of a high pressure casing; twisting the casing to form a seal; attaching the inlet port of the high pressure casing to a high pressure fluid line; and filtering particulates from the fluid within the high pressure fluid line. The method may further comprise the steps of inserting an O-ring into a recess formed in the outer threading of the dual threaded connector; and inserting an O-ring into a recess formed in the outer threading of the mesh filter. The method may also further comprise the steps of forming the mesh filter by aligning a perforated cylindrical pipe within an accordion shaped filter. The method may further comprise the step of cleaning the mesh filter without disassembly of the tool attachment of the high pressure fluid system. The method may still further comprise the step of attaching the outlet port of the dual threaded connector to a high pressure fluid line prior to a tool attachment of the high pressure fluid system.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is an exploded perspective view of an embodiment of the high pressure pre-tool filter system;

FIG. 2 is an exploded perspective view of an embodiment of the high pressure pre-tool filter system of the present invention with attachments for a high pressure fluid system;

FIG. 3A is an exploded view of an embodiment of the high pressure filter in an embodiment of the high pressure pre-tool filter system of the present invention;

FIG. 3B is a top view of an embodiment of the high pressure filter in an embodiment of the high pressure pre-tool filter system of the present invention;

FIG. 3C is an end view of an embodiment of the high pressure filter in an embodiment of the high pressure pre-tool filter system of the present invention;

FIG. 4A is a top view of an embodiment of the high pressure hose coupling in an embodiment of the high pressure pre-tool filter system of the present invention;

FIG. 4B is a perspective view of an embodiment of the high pressure hose coupling in an embodiment of the high pressure pre-tool filter system of the present invention;

FIG. 4C is a bottom view of an embodiment of the high pressure hose coupling in an embodiment of the high pressure pre-tool filter system of the present invention;

FIG. 5A is a bottom view of an embodiment of the pre-tool filter casing in an embodiment of the high pressure pre-tool filter system of the present invention;

FIG. 5B is a perspective view of an embodiment of the pre-tool filter casing in an embodiment of the high pressure pre-tool filter system of the present invention;

FIG. 5C is a top view of an embodiment of the pre-tool filter casing in an embodiment of the high pressure pre-tool filter system of the present invention;

FIGS. 6A-6B are cross sectional views of an embodiment of the high pressure hose coupling and the pre-tool filter casing with perspective views of the high pressure filter in an embodiment of the high pressure pre-tool filter system of the present invention;

FIG. 7 is a perspective view of an embodiment of construction equipment with the high pressure pre-tool filter system of the present invention installed within the hydraulic lines prior to the bucket of a wheel loader;

FIG. 8 is a perspective view of an embodiment of a high pressure fluid system of the prior art;

FIG. 9 is a perspective view of an embodiment of a high pressure fluid system with the high pressure pre-tool filter system of the present invention attached prior to a nozzle device of the high pressure fluid system;

FIG. 10 is a perspective view of an embodiment of a high pressure fluid system with the high pressure pre-tool filter system of the present invention attached in line along the high pressure lines; and

FIG. 11 is a perspective view of a further embodiment of a high pressure fluid system with the high pressure pre-tool filter system of the present invention attached along a handle and prior to a cleaning brush tool attachment.

### DETAILED DESCRIPTION OF THE INVENTION

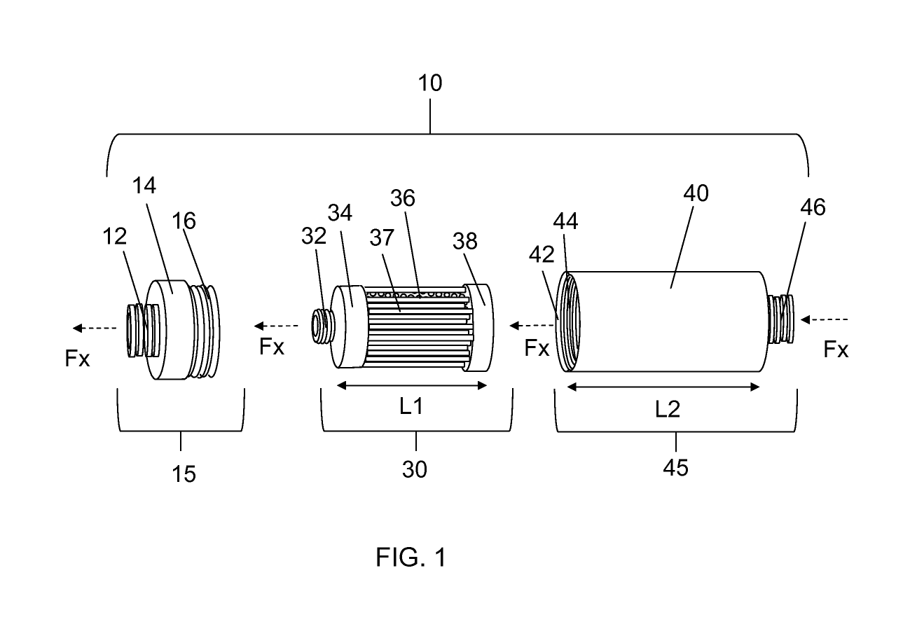

The cylindrical pre-tool filter system 10 has three components, a high pressure hose coupling 15, a high pressure filter 30, and a high pressure filter casing 45. The high pressure hose coupling 15 has a pipe fitting port 12 for connection to the fluid lines of a high pressure system and a dual threaded connector 16 to connect to the high pressure filter system 30. The dual threaded connector 16 of the high pressure hose coupling 15 is the inlet and the port 12 is the outlet with a flow path Fx going through the center of the pre-tool filter system 10 as shown in FIG. 1. The fitting 14 of the coupling 15 provides an easily gripable surface 9 to hold the coupling 15 and/or twist and connect the coupling 15 to the high pressure fluid lines. The high pressure filter 30 has an exterior threaded connector 32 extending from a filter cap 34 that is crimped or affixed to a mesh filter 36 formed from a rigid cylindrical pipe using for example epoxy. A stainless steel or other resilient mesh material is formed in an overlapping accordion shape to create an outer filter 37 that is installed around the mesh filter 36. The outer filter 37 provides a second layer of filtering and the rigidity and incompressibility of the accordion shape provides for extensive reuse of the filter through multiple high pressure operations and cleanings A filter end cap 38 is crimped or similarly affixed using epoxy to the mesh and outer filters 36 and 37. As shown a portion of the accordion shaped outer filter 37 has been removed to show the mesh filter 36 underneath. The filter casing 45 is an elongated cylinder 40 that surrounds the filter 30 that has a widened opening at one end of the cylinder 40 to encircle the high pressure filter 30 and connect to the dual threaded connector 16 of the hose coupling 15. A pipe fitting 46 at the opposing end of the casing 45 provides for the pre-tool filter 10 to connect to a high pressure fluid line from the outlet of a high pressure system. The port 12 of the hose coupling 15 and pipe fitting 46 of the filter casing 45 may be of different external diameters with different diameter of flow paths as required by the high pressure lines and tool attachments, with each having a National Pipe Thread (NPT) Standard taper and dimension to provide for the connection of standard high pressure lines and hose connectors to be attached to the pre-tool high pressure filter system 10.

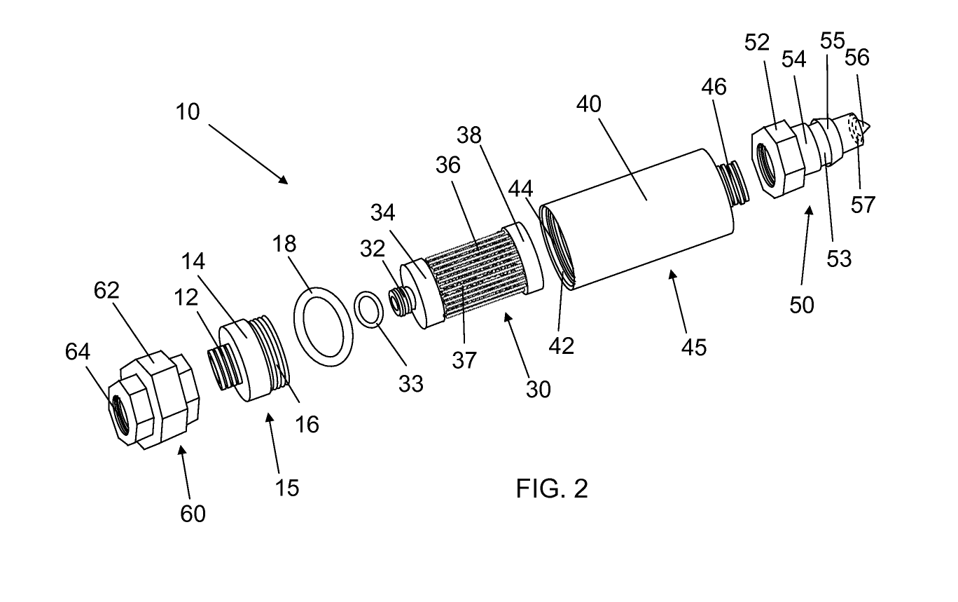

In a first embodiment, as shown in FIG. 2, Teflon® or other thread seal tape may be installed to the port 46 of the casing 45 and the port 46 may be connected to the locking nut 52 of a quick-disconnect high pressure hose fitting 50. A groove 53 abuts the barrel 54 of the fitting 50 to form a flange 55 that provides for the attachment of a high pressure fluid line using the flange to retain and attach the quick disconnect fitting 50 to a mating quick disconnect fitting (not shown). The mating quick disconnect fitting compresses a sealing pin 56 to provide for flow through an opening 57 formed in the fitting 50. The pin 56 provides a seal to stop the flow of fluid when the high pressure pre-tool filter 10 is detached from the high pressure fluid lines for cleaning. Additional O-rings 18 and 33 are used to seal the filter 30 and casing 45 to the coupling 15. The coupling port 12 may be attached to the high pressure fluid line similarly using a quick disconnect fitting 50 or alternatively a high pressure hose coupling 60 may be used. The high pressure hose coupling 60 has a locking nut 62 and internal threads 64 that are secured to threaded pipe fitting of port 12 of the coupling 15.

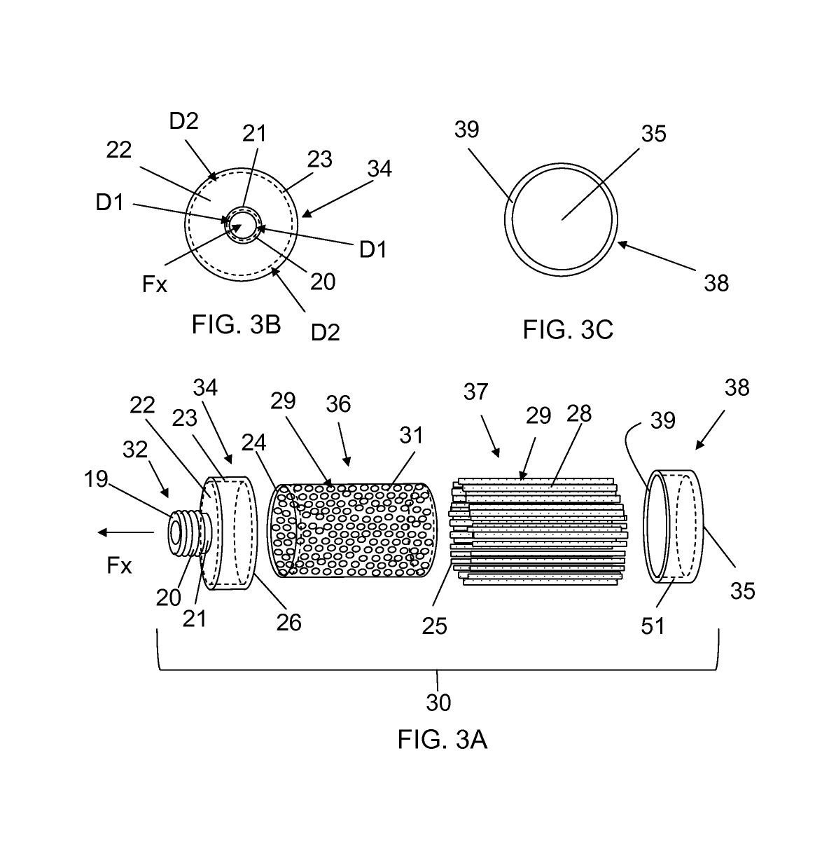

As shown in FIG. 3A, in a first embodiment of the high pressure filter 30, the connector 32 has a cylindrical rim 19 that forms an opening for fluid flow along the Fx direction. The cylindrical rim 19 has exterior threading 20 and a recess 21 to provide for seating of O-ring 33. The cylindrical rim 19 extends from the top cover 22 of the filter cap 34. The filter cap 34 is formed with a cylindrical sidewall 23 that extends to an opening having a larger interior diameter D2 at the base 26 of the cap than the smaller interior diameter D1 at the rim 19 as shown in FIG. 3B. The larger opening provides for the insertion of a first end 24 of the mesh filter 36 and a first end 25 of accordion shaped outer filter 37 that is crimped, epoxied, or otherwise affixed to the cap 34. The mesh filter 36 is formed from a cylindrical pipe 31 of stainless steel or other resilient material having a series of perforations 29. The series of perforations 29 provide a filter in the range of 50 microns to 250 microns and more preferably 125 microns to prevent clogging of brushes or other tool fixtures.

While some high pressure nozzles or tools may have filtering systems, some do not and those that do often require excessive amounts of time to remove and clean. For example, some carpet cleaning wand systems have an internal 200 micron filtering system that is within the brush attachment. However, to clean the filter requires the disassembly of the attachment to remove the filter. The filter must then be cleaned and then the attachment must be reassembled which often takes a significant amount of time to complete. Extensive disassembly may be purposely designed in the construction of a nozzle, brush, wand or other tool for safety to require that all components and the housing of the tool are properly secured prior to reuse to prevent damage or harm to a user in using an improperly assembled tool under high pressure. The pre-tool filter 10 may provide a filter at a lower mesh perforation size to collect debris prior to reaching the wand or tool attachment. The uniquely designed dual threaded connector 16 of the hose coupling 15 provides for safe removal, cleaning and reattachment of the pre-tool filter 10 with minimal down time.

The outer filter 37 is formed from folding stainless steel or other resilient material 28 having perforations 29 over on itself into an accordion shape as shown in FIG. 3A that provides a continuous second layering over the enclosed mesh filter 36 to more efficiently remove particulates from the high pressure lines prior to the tool attachment or other fluid power or heating system equipment. In this embodiment, the end cap 38 may be formed as a cup with a rim 39 and cylindrical sidewall 51 that extends to an enclosed base 35 to seat the mesh and accordion shaped filters 36 and 37. The flow from the casing inlet 46 is directed out and around the base 35, through the accordion shaped filter 37 and through the mesh filter 36 in a substantially perpendicular direction Fy to the flow path Fx. The difference in the inlet diameter D2 from the mesh filter 36 through the sidewall 23 and the outlet diameter D1 through the rim 19 is shown in a top view of the filter cap 34 in FIG. 3B. A top view of the end cap 38 showing the enclosed base 35 is shown in FIG. 3C.

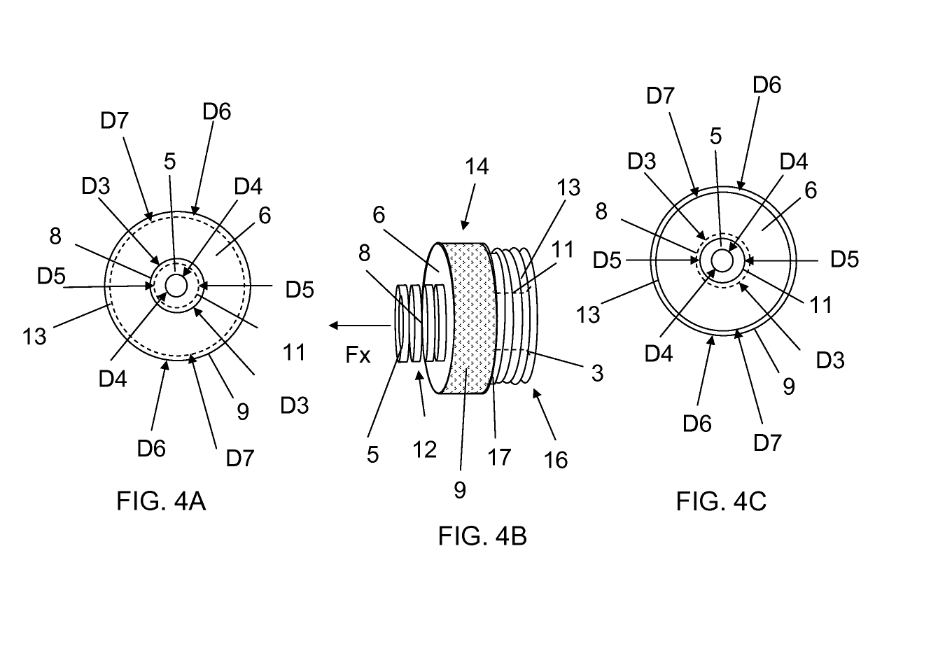

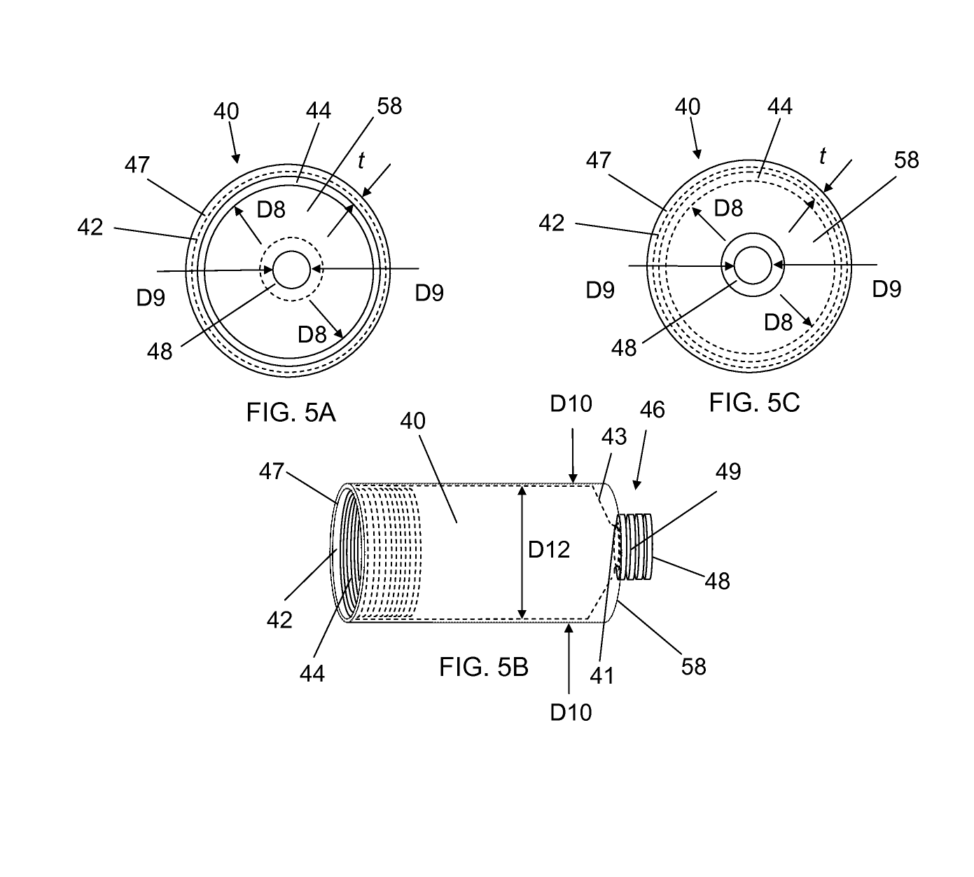

As shown in the top view in FIG. 4A, the pipe fitting port 12 of the high pressure coupling 15 has a cylinder 5 that extends out from the outer surface 6 of the fitting 14. The cylinder 5 of the port 12 has exterior threads 8 that provide for the connection of the coupling 15 to a fluid supply line or to a quick disconnect, a locking nut, or another high pressure fitting to releasably connect the coupling to a supply line prior to the high pressure tool attachment. The fitting 14 may have a smooth or knurled exterior surface 9 that provides for a user to form a grip on the fitting 14 to twist and connect port 12 in line with the high pressure fluid lines or to a tool attachment. The connector 16, as shown in FIG. 4B, of the high pressure coupling 15 is uniquely designed with interior threads 11 for the connection of the high pressure filter 30 and exterior threads 13 for the connection of the casing 45. The diameter D3 and dimension of the pipe fitting connector threads 8 are a NPT Standard taper and dimension with an internal diameter D4 that is dimensioned to be substantially the same diameter as the flow path Fx through the high pressure fluid lines to maintain adequate pressures. The dual threaded connector 16 of the coupling 15 then widens from the flow path diameter D3 to diameter D5 to accommodate for the interior threads 11 that provide for a threaded attachment with the exterior threads 20 of the high pressure filter 30. A radius 3 is formed at the base of the interior threads 11 to provide for the threads to seal against the O-ring 33 installed on the high pressure filter 30. The gripping surface 9 of the fitting 14 has a larger diameter D6 than the diameter D7 of the exterior threads 13 of the dual threaded connector 16 to more easily attach the filter casing 45 to the coupling 15. A bottom view of the high pressure coupling 15 is shown in FIG. 4C. As shown in a bottom view from the opening in FIG. 5A, the filter casing 45 is formed from a cylindrical housing 40 with an end portion 58 that has a wall thickness t that is of any adequate dimension to sustain the fluid pressures through the pre-tool filter system 10. The internal threads 44 that are positioned substantially closer to the opening than the end portion 58 although the threads 44 may extend through any portion of the cylinder 40 as necessary based on the dimensions and pressure requirements of the pre-tool filter system 10 and high pressure fluid system. The threads 44 have an interior diameter D8 that is minimally larger than the diameter D7 of the exterior threads 13 of the dual threaded connector 16. A radius 42 is formed within the base of the cylindrical wall 47. The outlet connector 46 is formed or affixed at the opposing end of the cylinder 40 as a tubular extension 48 that has exterior threads 49 that are of a NPT Standard taper and dimension. The internal diameter D9 of the opening formed by the tubular extension 48 may be of the same dimension or slightly larger in dimension than the diameter D4 of the hose coupling 15 to receive flow from the outlet of the high pressure system fluid lines. A radius 41 and bevel 43 may be formed to angle the interior surface of the end portion 58 to provide for rotational flow of fluid moving through the casing 45 and entering the high pressure filter 30 thereby absorbing vibrations and reducing pulsations within the high pressure fluid lines. A top view of the filter casing 45 is shown in FIG. 5C.

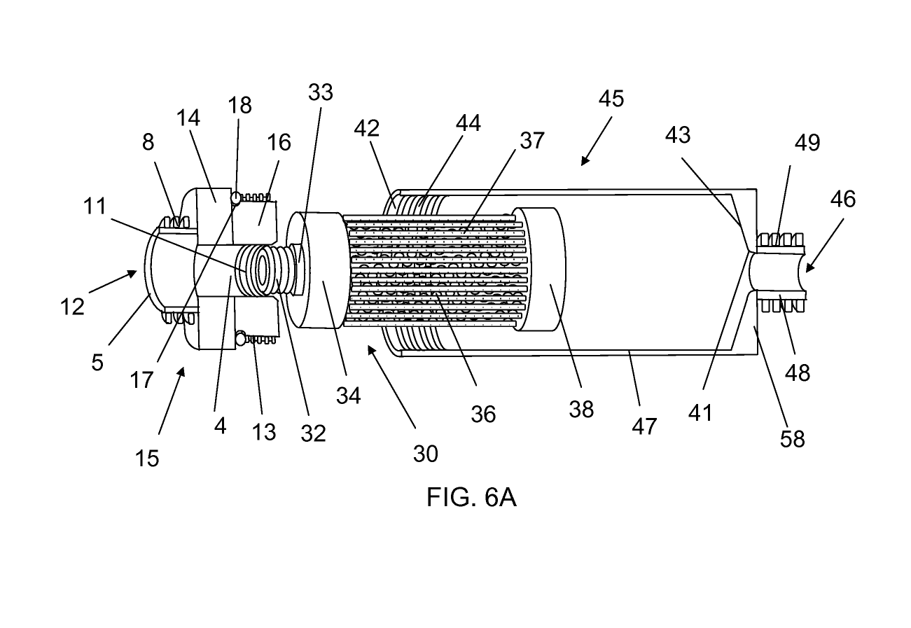

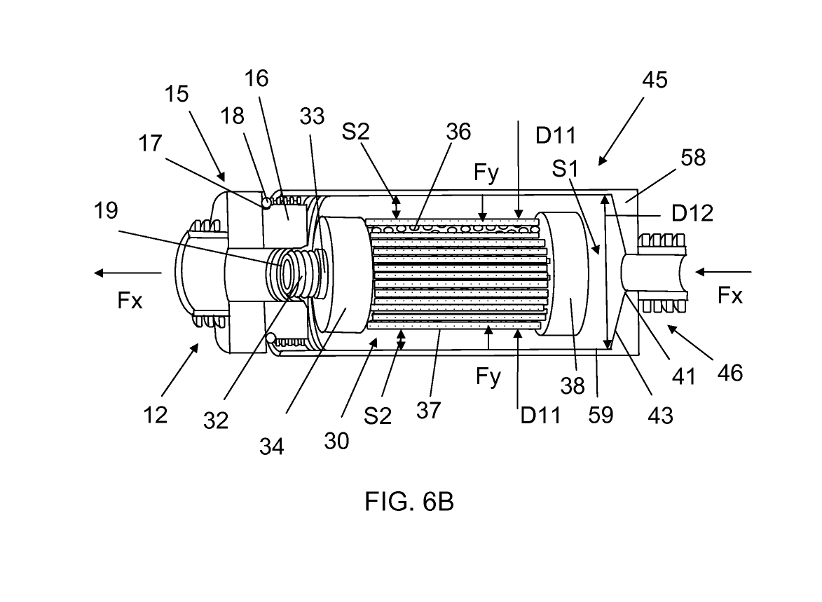

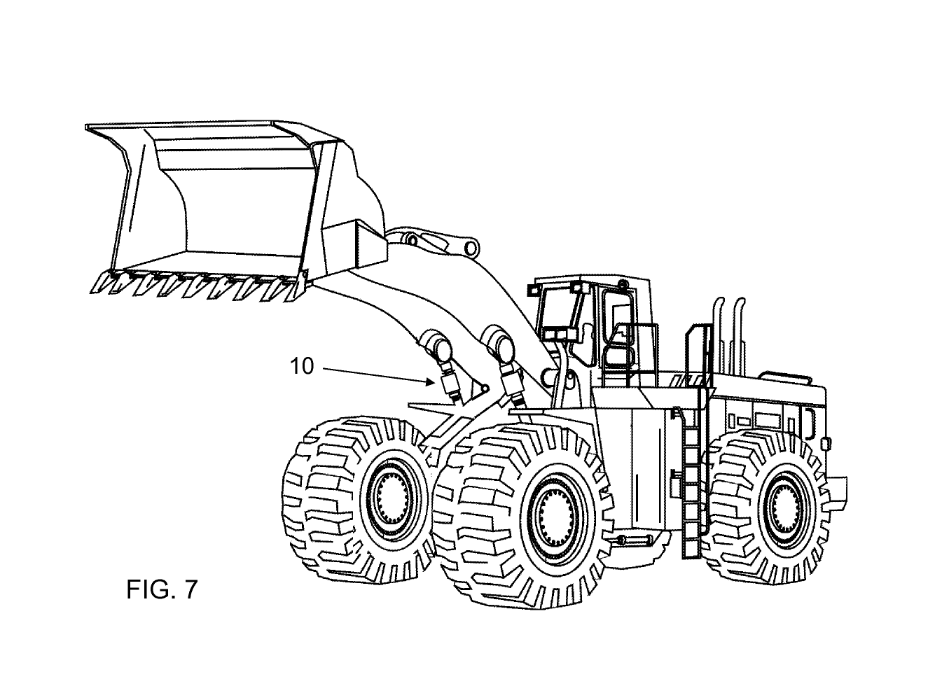

As shown in FIG. 6A, an O-ring 33 is installed in the recess 21 at the base of the exterior threads 20 of the high pressure filter 30. The high pressure filter 30 is then connected to the dual threaded connector 16 by holding the fitting 14 of the coupling 15 and rotating the filter 30 into the interior threads 11 thereby compressing the soft material of the O-ring 33 to seal the connection of the filter 30 and coupling 15. Parallel, fastening threads are used for the high pressure connection to provide for the filter 30 to be hand tightened and then using 2 to 3 turns of a wrench the O-ring 33 is compressed and a fluid tight seal is formed. An O-ring 18 is installed in recess 17 along the lower surface of the fitting 14 and in the upper portion of the exterior threads 13 of the dual threaded connector 16 and the threads 13 are then inserted into the casing 45. By holding the fitting 14, the casing 45 is rotated to connect the casing 45 to the high pressure coupling 15 around the high pressure filter 30. The exterior threads 13 of the dual threaded connector 16 are similarly parallel fastening threads that provide for a hand tightening of the casing 45 and then 2-3 turns of a wrench to compress the O-ring 18 and seal the casing 45 to the coupling 15. The radius 42 provides an edge to capture and compress the O-ring 18. The outer diameter D10 of the cylinder may be substantially similar in dimension to the outer diameter D6 of the fitting 14 so that when fitted on the high pressure coupling 15, there is a nearly flush transition from the high pressure coupling 15 to the pre-tool filter casing 45 or alternatively the casing may be of a wider dimension with a thicker wall thickness to accommodate higher pressures. As shown in FIG. 6B, when the high pressure filter 30 is installed to the coupling 15 and the casing 45 is connected to the coupling 15 a space S1 is formed at the end portion 58 of the casing 45 because the overall length L1 of the high pressure filter 30 is substantially shorter than the length L2 of the casing 45. This space S1 with the beveled end 43 and radius 41 at the point of inlet flow provides for rotational flow for a volume of high pressure fluid that has not as yet entered the high pressure filter 30. The outer filter portion 37 of the high pressure filter 30 is also of a diameter D11 that is minimally smaller in diameter than the interior diameter D12 of the casing 45 creating a smaller space S2 that provides for flow to be directed from the inlet around the end cap 38 of the filter 30 and through the space S2 to enter the filter in a substantially perpendicular direction Fy to the high pressure flow Fx thereby forcing more fluid along the entire length L1 of the filter 30 to enter through the accordion shaped filter 37, through the mesh filter 36 and out through the opening in the rim 19 of the high pressure filter 30 and thereby providing greater use of the surface area of the filter 30 to more efficiently remove particulates from the fluid of the high pressure system. In further embodiments, the threading of one component may be reversed such as from inner threading to outer threading to accommodate and compliment the threading of another component.

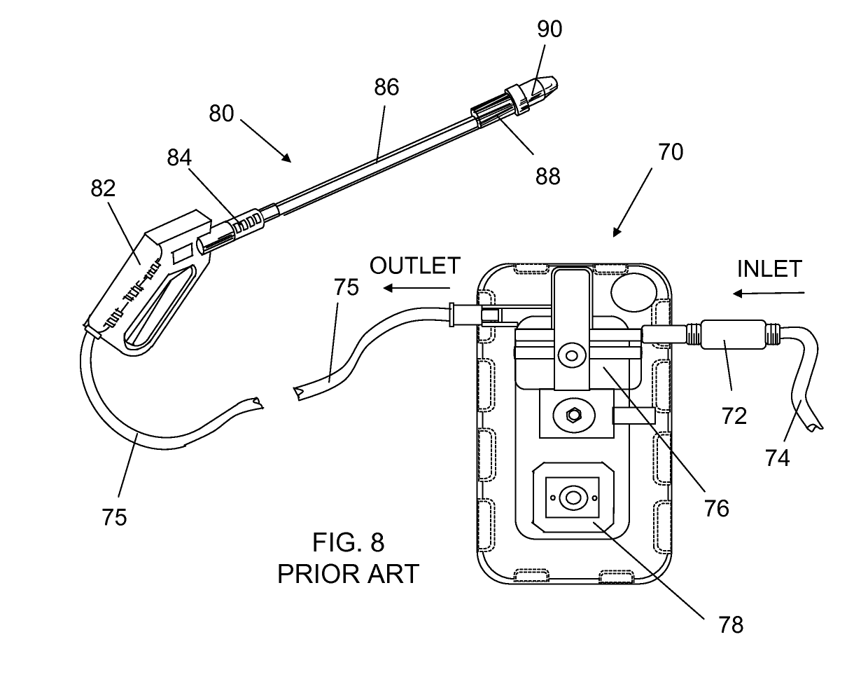

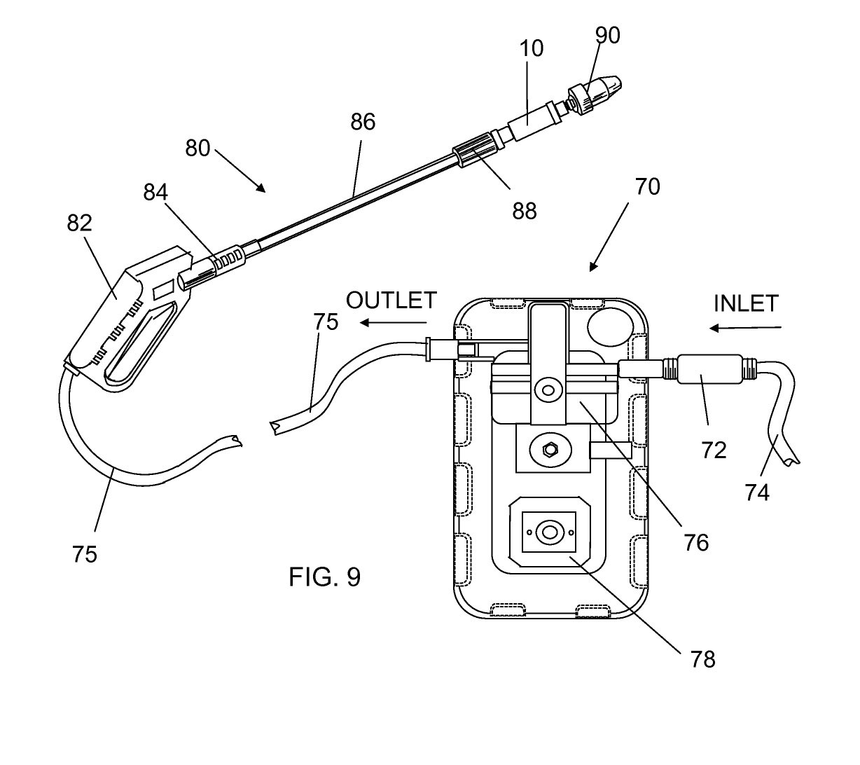

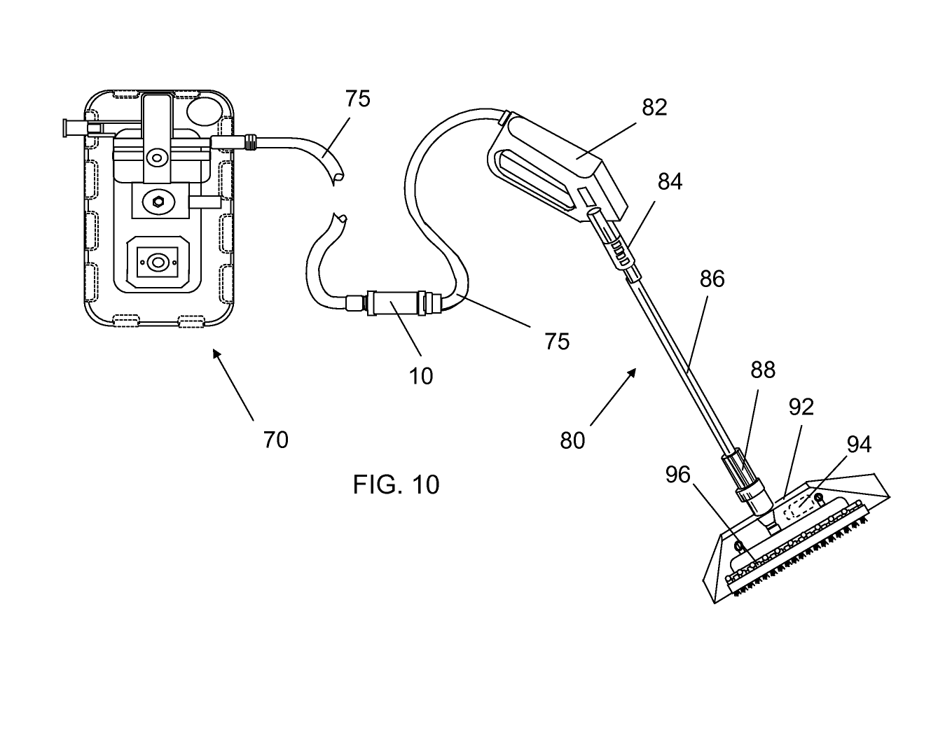

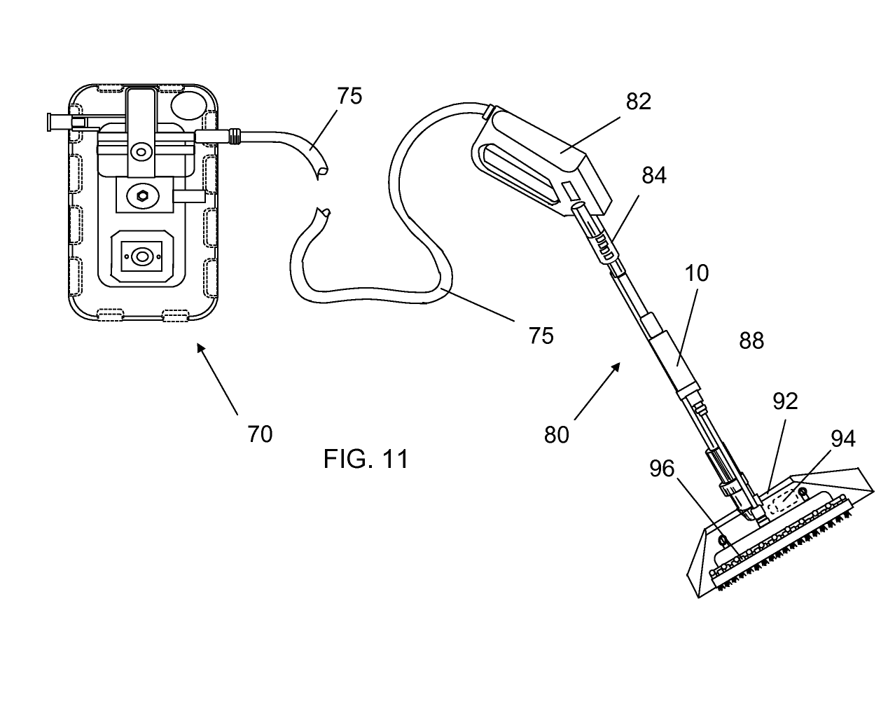

The connector 16 is of a length and diameter with as many exterior threads 13 as necessary to mate with the threads 44 of the pre-tool filter casing 45 based on the diameter, thickness and other dimensions of the casing cylinder 40 as required by the high pressure requirements of the application and equipment. For example, the coupling 15 and casing 45 may be of larger dimensions to accommodate applications at higher pressures such as for use in hydraulic power systems that are used in for example construction equipment. As shown in FIG. 7, the high pressure pre-tool filter system 10 may be installed prior to hydraulic cylinders to prevent particulates from damaging pistons or other components within the equipment. In a high pressure cleaning system 70 of the prior art as shown in FIG. 8, a low pressure inlet filter 72 is installed to remove particulates from the inlet line 74 prior to the system pump 76 and motor 78. The high pressure outlet hydraulic line 75 is connected to a tool 80 that may have a handle 82, a control panel 84, a wand 86, a tool connector 88 and nozzle 90 or other device. As shown in FIG. 9, the high pressure pre-tool filter system 10 may be installed between the tool connector 88 and the nozzle 90 to prevent clogging of the nozzle 90. The high pressure pre-tool filter 10 may further be installed in line with the high pressure outlet lines 75 to remove particulates prior to the tool or other cleaning device especially in lengthy pressure lines or lines that are infrequently used as shown in FIG. 10. As shown in FIG. 11, the pre-tool filter 10 may also be installed prior to a tool such as carpet cleaning brush attachment 92 that has multiple nozzle brushes 96. If the nozzle brushes become clogged, taking apart the brush attachment 92 and cleaning may take several hours. The brush attachment 92 may further have an internal filter 94 that if clogged may also require several hours to take apart the attachment and clean or replace the filter 94 where many filters are of paper other materials that readily degrade during each power or wash cycle. As an example, the reusable pre-tool high pressure filter 10 may be installed with a lower rating micron filter than the internal filter 94 to remove particulates prior to the internal filter 94 to prevent clogging of the filter, and the necessity for cleaning or replacement of the internal filter. The easy access to clean the pre-tool filter 10 allows the filter 30 to be removed, cleaned and re-installed within a matter of minutes.

The invention has been described in detail with particular reference to certain preferred embodiments thereof, but it will be understood that variations and modifications such as reversing inner threading to outer threading can be effected within the spirit and scope of the invention. While references are made to inner, outer, upper, and lower, these terms are used merely to describe the relationship of components and not to limit the operation of the present invention to any one orientation.

What is claimed is:

1. An apparatus for removing particulates from a high pressure fluid line, comprising:
a dual threaded connector;
a filter having outer threading;
a casing having inner threading;
and wherein the outer threading of the filter is attached to inner threading on the dual threaded connector, the inner threading on the casing is connected to outer threading on the dual threaded connector, the dual threaded connector and casing are connected in line with a high pressure fluid line and the filter removes particulates from fluid within the fluid line.

2. The apparatus for removing particulates from a high pressure fluid line of claim 1 wherein the filter further comprising a cylindrical mesh filter layered within an accordion shaped filter.

3. The apparatus for removing particulates from a high pressure fluid line of claim 2 wherein the mesh filter and accordion filter are resiliently formed to be reused through numerous high pressure fluid power, wash and cleaning cycles.

4. The apparatus for removing particulates from a high pressure fluid line of claim 1 wherein the filter further comprising material having perforations in a range of 50 microns to 250 microns.

5. The apparatus for removing particulates from a high pressure fluid line of claim 1 wherein the dual threaded connector further comprises a radius for an O-ring within the dual threaded connector inner threading and a recess within the dual threaded connector outer threading.

6. The apparatus for removing particulates from a high pressure fluid line of claim 1 wherein the filter comprises a recess for an O-ring within the filter outer threading.

7. The apparatus for removing particulates from a high pressure fluid line of claim 1 wherein the casing further comprises a radius for an O-ring within the casing inner threading.

8. The apparatus for removing particulates from a high pressure fluid line of claim 1 wherein the threads of the dual threaded connector, mesh filter and casing further comprise parallel, fastening threads and at least one O-ring is used at each connection to form a seal.

9. The apparatus for removing particulates from a high pressure fluid line of claim 1 wherein the pre-tool filter system is used in one of at least high pressure pumping systems, heating systems, or hydraulic powered equipment.

10. A pre-tool high pressure filter, comprising:
a dual threaded connector;
a mesh filter having outer threading;
a casing having inner threading;
and wherein the outer threading of the mesh filter is attached to inner threading on the dual threaded connector, the inner threading on the casing is connected to outer threading on the dual threaded connector, the dual threaded connector and casing are removably attached prior to a tool attachment of high pressure fluid system and the pre-tool high pressure filter removes particulates from the fluid of the high pressure fluid system.

11. The pre-tool high pressure filter of claim 10 wherein the pre-tool filter may be removed, cleaned and re-attached prior to the tool attachment of the high pressure fluid system without disassembly of the tool attachment.

12. The pre-tool high pressure filter of claim 10 wherein the pre-tool filter is of a smaller micron rating than an internal filter of the tool attachment.

13. The pre-tool high pressure filter of claim 10 wherein the high pressure fluid system is used in construction equipment.

14. The pre-tool high pressure filter of claim 10 wherein the high pressure fluid system is used in carpet cleaning equipment.

15. A method of installing a reusable pre-tool high pressure filter, comprising the steps of:
inserting outer threads of a mesh filter into inner threads of a dual threaded connector;
twisting the mesh filter to form a seal;
inserting the outer threads of the dual threaded connector into the inner threads of a high pressure casing;
twisting the casing to form a seal;
attaching the inlet port of the high pressure casing to a high pressure fluid line that is the outlet from a high pressure fluid system;
attaching an outlet port of the dual threaded connector to a high pressure fluid tool attachment; and
filtering particulates from the fluid within the high pressure fluid line.

16. The method of installing a reusable pre-tool high pressure filter of claim 15, further comprising the steps of:
detaching the inlet port of the high pressure casing from the high pressure fluid line;
twisting the casing to remove the casing from the dual threaded connector;
twisting the mesh filter to remove the filter from the dual threaded connector;
cleaning the mesh filter;
twisting the mesh filter within the inner threads of the dual threaded connector to form a seal;
inserting the outer threads of the dual threaded connector into the inner threads of a high pressure casing;
twisting the casing to form a seal;
attaching the inlet port of the high pressure casing to a high pressure fluid line; and
filtering particulates from the fluid within the high pressure fluid line.

17. The method of installing a reusable pre-tool high pressure filter of claim 15, further comprising the steps of:
inserting an O-ring into a recess formed in the outer threading of the dual threaded connector; and
inserting an O-ring into a recess formed in the outer threading of the mesh filter.

18. The method of installing a reusable pre-tool high pressure filter of claim 15, further comprising the steps of:
forming the mesh filter by aligning a perforated cylindrical pipe within an accordion shaped filter.

19. The method of installing a reusable pre-tool high pressure filter of claim 15, further comprising the steps of:
cleaning the mesh filter without disassembly of the tool attachment of the high pressure fluid system.

20. The method of installing a reusable pre-tool high pressure filter of claim 15, further comprising the steps of:
attaching the outlet port of the dual threaded connector to a high pressure fluid line prior to a tool attachment of the high pressure fluid system.
